(19) United States
(12) Patent Application Publication
(10) Pub. No.: US 2016/0212388 A1
(43) Pub. Date: Jul. 21, 2016

(54) SURVEILLANCE APPARATUS

(71) Applicant: FUJI XEROX CO., LTD., Tokyo (JP)

(72) Inventors: Yoshihiko NEMOTO, Kanagawa (JP); Motofumi BABA, Kanagawa (JP); Hidekiyo TACHIBANA, Kanagawa (JP)

(21) Appl. No.: 14/932,144

(22) Filed: Nov. 4, 2015

(30) Foreign Application Priority Data
Jan. 21, 2015 (JP) 2015-009854

(51) Int. Cl. H04N 7/18; H04N 5/225; H04N 1/00; G06K 9/00

(52) U.S. Cl. CPC H04N 7/188; G06K 9/00771; H04N 5/225; H04N 1/0088; H04N 2201/0082

(57) ABSTRACT

Provided is a surveillance apparatus including a detection unit that detects an intruder who intrudes in a predetermined surveillance region, and an induction unit that induces the intruder when the intruder is detected.

### CROSS-REFERENCE TO RELATED APPLICATIONS

This application is based on and claims priority under 35 USC 119 from Japanese Patent Application No. 2015-009854 filed Jan. 21, 2015.

### BACKGROUND

(i) Technical Field

The present invention relates to a surveillance apparatus.

(ii) Related Art

In the related art, a surveillance apparatus, for which a predetermined surveillance region is set, and which enables a surveillance camera to capture images in the surveillance region, is disclosed. In this case, for example, the images captured by the surveillance camera are transmitted to a surveillance center via a public communication network or the like, and at the occurrence of abnormality, a state of the surveillance region may be confirmed from the surveillance center.

### SUMMARY

According to an aspect of the invention, there is provided a surveillance apparatus including:

a detection unit that detects an intruder who intrudes in a predetermined surveillance region; and

an induction unit that induces the intruder when the intruder is detected.

### BRIEF DESCRIPTION OF THE DRAWINGS

Exemplary embodiments of the present invention will be described in detail based on the following figures, wherein:

FIG. 1 is a view illustrating the exterior of an image forming apparatus according to exemplary embodiments;

FIG. 2 is a view illustrating the internal structure of the image forming apparatus according to the exemplary embodiments;

FIG. 3 is a block diagram illustrating an example of a functional configuration of a control device;

FIG. 4 is a flowchart illustrating an operation of the image forming apparatus according to a first exemplary embodiment;

FIG. 5 is a flowchart illustrating an operation of the image forming apparatus according to a second exemplary embodiment;

FIG. 6 is a flowchart illustrating an operation of the image forming apparatus according to a third exemplary embodiment; and

FIG. 7 is a diagram exemplifying a case in which a coordinated operation between the image forming apparatus and other equipment is performed.

### DETAILED DESCRIPTION

### Description of Entire Image Forming Apparatus

Hereinafter, exemplary embodiments will be described in detail with reference to the accompanying drawings.

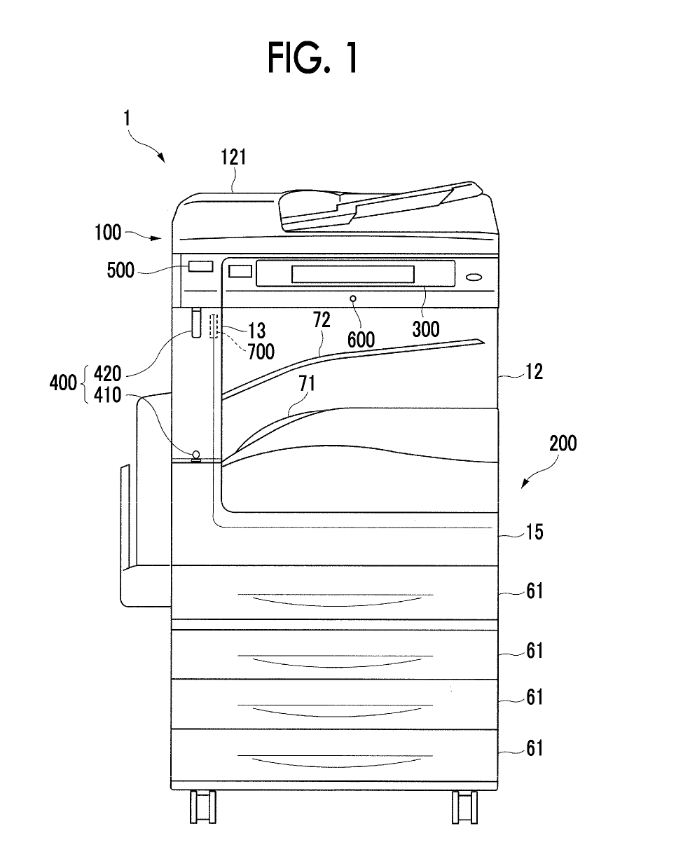

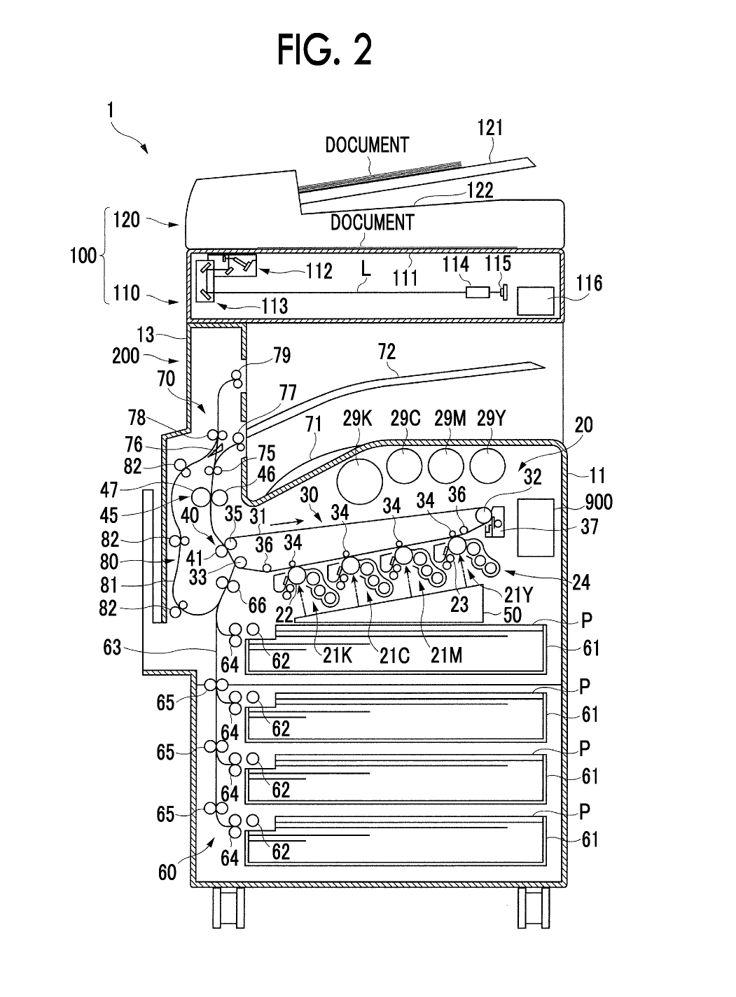

FIG. 1 is a view illustrating the exterior of an image forming apparatus 1 according to exemplary embodiments. FIG. 2 is a view illustrating an internal structure of the image forming apparatus 1 according to the exemplary embodiments.

The image forming apparatus 1 includes an image readout device 100 and an image recording device 200. The image readout device 100 reads an image of a document, and the image recording device 200 is an example of an image forming unit that forms an image on a recording medium (hereinafter, which may be representatively referred to as “paper”). The image forming apparatus 1 further includes a user interface (UI) 300 that receives an operation input from a user or displays various types of information for the user.

The image forming apparatus 1 further includes a human detection sensor 400 that detects a human; a camera 500 that captures images of the vicinity of the image forming apparatus 1; a microphone 600 that acquires a sound; a speaker 700 that outputs a sound; and a control device 900 that controls an operation of the entire image forming apparatus 1.

The image readout device 100 is disposed in an upper portion of the image forming apparatus 1, and the image recording device 200 is disposed below the image readout device 100, and has the control device 900 built therein. The user interface 300 is disposed on a front side of the upper portion of the image forming apparatus 1, that is, the user interface 300 is disposed on a front side of an image readout unit 110 (to be described later) of the image readout device 100.

The human detection sensor 400 is disposed on a front side of a readout device-supporting portion 13 (to be described later). The camera 500 is disposed on a left side of the user interface 300, and the microphone 600 is disposed on a front side of the user interface 300. The speaker 700 is disposed on a right side of the readout device-supporting portion 13.

First, the image readout device 100 will be described.

The image readout device 100 includes the image readout unit 110 and a document transporting unit 120. The image readout unit 110 reads an image of a document, and the document transporting unit 120 transports the document to the image readout unit 110. The document transporting unit 120 is disposed in an upper portion of the image readout device 100, and the image readout unit 110 is disposed in a lower portion of the image readout device 100.

The document transporting unit 120 includes a document accommodation unit 121 and a document output unit 122, and transports a document from the document accommodation unit 121 to the document output unit 122. The document accommodation unit 121 accommodates a document, and the document output unit 122 outputs the document that is transported from the document accommodation unit 121.

The image readout unit 110 includes platen glass 111; a light irradiating unit 112 that irradiates a readout surface (imaged surface) of a document with light; a light guiding unit 113 that guides light L with which the light irradiating unit 112 irradiates the readout surface of the document, and which is reflected by the readout surface of the document; and an image forming lens 114 that forms an optical image of the light L which is guided by the light guiding unit 113. The image readout unit 110 is formed of a photoelectric conversion element such as a charge coupled device (CCD) image sensor that converts the light L, the image of which is formed by the image forming lens 114, into electrical signals. The image readout unit 110 includes a detection unit 115 that detects the formed optical image, and the image processing unit 116 which is electrically connected to the detection unit 115 and to which electrical signals obtained by the detection unit 115 are sent.

The image readout unit 110 reads an image of a document that is transported by the document transporting unit 120, and an image of a document mounted on the platen glass 111.

Hereinafter, the image recording device 200 will be described.

The image recording device 200 includes an image forming unit 20 that forms an image on paper; a paper supply unit 60 that supplies the paper P to the image forming unit 20; a paper output unit 70 that outputs the paper P on which the image is formed by the image forming unit 20; and a reverse transporting unit 80 that reverses the back surface of the paper P, on one surface of which the image is formed by the image forming unit 20, and transports the reversed paper P toward the image forming unit 20 again.

The image forming unit 20 includes four image forming units 21Y for yellow, 21M for magenta, 21C for cyan, and 21K for black which are disposed side by side with a predetermined gap formed therebetween. Each of the image forming units 21 includes a photoconductor drum 22; a charger 23 that equally charges the surface of the photoconductor drum 22 with electricity; and a developing device 24 that develops and visualize an electrostatic latent image using predetermined color component toners, with the electrostatic latent image formed by laser beams irradiating from an optical unit 50. Toner cartridges 29Y, 29M, 29C, and 29K are provided in the image forming unit 20, and supply color toners to the developing devices 24 of the image forming units 21Y, 21M, 21C, and 21K, respectively.

The image forming unit 20 includes the optical unit 50 that is disposed below the image forming units 21Y, 21M, 21C, and 21K, and irradiates the photoconductor drums 22 of the image forming units 21Y, 21M, 21C, and 21K with laser beams. In addition to a semiconductor laser, a modulator, and the like which are not illustrated, the optical unit 50 includes a polygon mirror (not illustrated) that scans laser beams, which are emitted from the semiconductor laser, in a deflective manner; a glass window (not illustrated) through which the laser beams pass; and a frame (not illustrated) for the enclosure of configuration members.

The image forming unit 20 includes an intermediate transfer unit 30 that multi-transfers color toner images on an intermediate transfer belt 31, with the color toner images formed on the photoconductor drums 22 of the image forming units 21Y, 21M, 21C, and 21K; a secondary transfer unit 40 that transfers the toner images on the paper P, with the toner images superimposed over each other on the intermediate transfer unit 30; and a fixing device 45 that fixes the toner images formed on the paper P via heating and pressing.

The intermediate transfer unit 30 includes the intermediate transfer belt 31; a drive roller 32 that drives the intermediate transfer belt 31; and a tension roller 33 that applies predetermined tension to the intermediate transfer belt 31. The intermediate transfer unit 30 includes plural (four in the exemplary embodiments) primary transfer rollers 34 and a backup roller 35. The primary transfer rollers 34 face the photoconductor drums 22, respectively, with the intermediate transfer belt 31 interposed between the photoconductor drums 22 and the primary transfer rollers 34, and transfer the toner images formed on the photoconductor drums 22 on the intermediate transfer belt 31. The backup roller 35 faces a secondary transfer roller 41 (to be described later) with the intermediate transfer belt 31 interposed between the secondary transfer roller 41 and the backup roller 35.

The intermediate transfer belt 31 is wrapped in a tension manner around plural rotating members such as the drive roller 32, the tension roller 33, the plural primary transfer rollers 34, the backup roller 35, and a driven roller 36. The intermediate transfer belt 31 is driven to circulate around the rotating members at a predetermined speed in a direction of the arrow by the drive roller 32 that is driven to rotate by a drive motor (not illustrated). The intermediate transfer belt 31 is molded with rubber, resin, or the like.

The intermediate transfer unit 30 includes a cleaning device 37 that removes residual toners and the like present on the intermediate transfer belt 31. The cleaning device 37 removes residual toners, paper debris, and the like from the surface of the intermediate transfer belt 31 after a process of transferring the toner images is completed.

The secondary transfer unit 40 includes the secondary transfer roller 41 that is provided at a secondary transfer position, and enables secondary transfers of the images on the paper P by pressing the backup roller 35 via the intermediate transfer belt 31. The secondary transfer position is formed by the secondary transfer roller 41, and the backup roller 35 facing the secondary transfer roller 41 with the intermediate transfer belt 31 interposed between the backup roller 35 and the secondary transfer roller 41, at which the toner images transferred on the intermediate transfer belt 31 is transferred on the paper P.

The fixing device 45 fixes the images (toner images) (which are secondarily transferred on the paper P by the intermediate transfer unit 30) on the paper P by heating and pressing the images using a heating-fixing roller 46 and a pressing roller 47.

The paper supply unit 60 includes paper accommodating units 61, each of which accommodates pieces of paper that images are recorded on; feeding rollers 62, each of which feeds out the paper P accommodated in the corresponding paper accommodating unit 61; a transporting path 63 on which the paper P fed out by the feeding roller 62 is transported; and transport rollers 64, 65, and 66 which are disposed along the transporting path 63, and transport the paper P fed out by the feeding roller 62 to the secondary transfer position.

The paper output unit 70 is provided above the image forming unit 20, and includes a first carrying tray 71 and a second carrying tray 72. The first carrying tray 71 carries pieces of paper with images formed by the image forming unit 20, and the second carrying tray 72 is provided between the first carrying tray 71 and the image readout device 100, and carries pieces of paper with images formed by the image forming unit 20.

The paper output unit 70 is provided on a downstream side of the fixing device 45 in a direction of transport, and includes a transport roller 75 and a switching gate 76. The transport roller 75 transports the paper P with a fixed toner image, and the switching gate 76 is provided on a downstream side of the transport roller 75 in the direction of transport, and switches between the directions of transport of the paper P. The paper output unit 70 includes a first output roller 77 that is disposed on a downstream side of the switching gate 76 in the direction of transport, and outputs the paper P, which is being transported in one (right side in FIG. 2) of the directions of transport switched by the switching gate 76, to the first carrying tray 71. The paper output unit 70 includes a transport roller 78 and a second output roller 79 which are disposed on the downstream side of the switching gate 76 in the direction of transport. The transport roller 78 transports the paper P which is being transported in the other (upper side in FIG. 2) of the directions of transport switched by the switching gate 76, and the second output roller 79 outputs the paper P transported by the transport roller 78 to the second carrying tray 72.

The reverse transporting unit 80 includes a reverse transporting path 81 which is disposed beside the fixing device 45 and on which the paper P is transported, with the paper P reversed by rotating the transport roller 78 in a direction opposite to a direction in which the paper P is output to the second carrying tray 72. Plural transport rollers 82 are provided along the reverse transporting path 81. The paper P is transported and fed back to the secondary transfer position by the transport rollers 82.

The image recording device 200 includes a device body frame 11 and a device housing 12. The device body frame 11 supports the image forming unit 20, the paper supply unit 60, the paper output unit 70, the reverse transporting unit 80, and the control device 900 directly or indirectly, and the device housing 12 is attached to the device body frame 11, and forms an external surface of the image forming apparatus 1.

The device body frame 11 includes the readout device-supporting portion 13 that includes the switching gate 76, the first output roller 77, the transport roller 78, the second output roller 79, and the like therein, with these components disposed in one end portion of the image forming apparatus 1 in a lateral direction, extends in a vertical direction, and supports the image readout device 100. The readout device-supporting portion 13 supports the image readout device 100 along with a rear portion of the device body frame 11.

The image recording device 200 includes a front cover 15 that is provided as a part of the device housing 12 on a front side of the image forming unit 20, and is installed such that the front cover 15 may be opened and closed with respect to the device body frame 11.

A user may open the front cover 15, and replace the intermediate transfer unit 30 or the toner cartridges 29Y, 29M, 29C, and 29K of the image forming unit 20 with new ones.

For example, the user interface 300 is a touch panel. Since the user interface 300 is a touch panel, various types of information such as image forming conditions of the image forming apparatus 1 are displayed on the touch panel. A user inputs image forming conditions or the like by touching the touch panel.

For example, the touch panel includes a built-in backlight, and when the backlight is turned on, a user may have improved visibility of the touch panel.

The human detection sensor 400 detects a human approaching the image forming apparatus 1.

The image forming apparatus 1 has plural power modes (operation modes) which have different power consumption. Any one of a normal mode, a standby mode, and a sleep mode is set as an electric power mode. The normal mode represents a mode in which a job is generated, and the image recording device 200 forms an image, the standby mode represents a mode in which the image forming apparatus 1 is in standby waiting for the generation of a job, and the sleep mode represents a mode in which power consumption is reduced. In the sleep mode, the supply of power to the image forming unit 20 and the like is stopped, for example, and thus power consumption is reduced.

When an image formation process executed by the image recording device 200 is completed, the image forming apparatus 1 transitions from the normal mode to the standby mode. When a job is not generated for a predetermined time after the transition to the standby mode, the power mode transitions to the sleep mode.

In contrast, when predetermined return conditions are established, the image forming apparatus 1 returns to the normal mode from the sleep mode. For example, when the control device 900 receives a job, it is determined that the return conditions are established. In the exemplary embodiments, when the human detection sensor 400 detects a human, it is also determined that the return conditions are established.

In the exemplary embodiments, the human detection sensor 400 is configured to include a pyroelectric sensor 410 and a reflective sensor 420. Also in the sleep mode, power is supplied to the pyroelectric sensor 410, and the pyroelectric sensor 410 detects whether a human enters a predetermined detection region, and when the pyroelectric sensor 410 detects that a human has entered the predetermined detection region, power is supplied to the reflective sensor 420, and thus the reflective sensor 420 detects that the human is present in the predetermined detection region.

The pyroelectric sensor 410 includes a pyroelectric element, a lens, an IC, a printed substrate, and the like, and detects the amount of change in infrared light caused by a motion of a human. When the detected amount of change exceeds a predetermined reference value, the pyroelectric sensor 410 detects that a human has entered the predetermined detection region.

The reflective sensor 420 includes an infrared-emitting diode that is a light emitting diode, and a photodiode that is a light receiving diode. When a human enters the detection region, infrared light emitted from the infrared-emitting diode is reflected by the human, and is incident on the photodiode. The reflective sensor 420 detects whether a human is present in the detection region based on a voltage output from the photodiode.

The pyroelectric sensor 410 is set to have a detection region that is wider than that of the reflective sensor 420. The pyroelectric sensor 410 has power consumption that is lower than that of the reflective sensor 420. In the exemplary embodiments, also in the sleep mode, power to the pyroelectric sensor 410 is turned on, and when the pyroelectric sensor 410 detects a human, power to the reflective sensor 420 is turned on. When the reflective sensor 420 detects a human within a predetermined time after the pyroelectric sensor 410 has detected the human, the power mode returns to the normal mode from the sleep mode. In contrast, when the reflective sensor 420 does not detect a human within the predetermined time, power to the reflective sensor 420 is turned off.

In this manner, power consumption may be reduced compared to a configuration in which power to the reflective sensor 420 is always turned on in the sleep mode.

The number of so-called erroneous detection events, in which the image forming apparatus 1 in the exemplary embodiments erroneously detects a human without an intention to use the image forming apparatus 1, a dog, or the like, and returns to the normal mode from a power saving mode, is reduced compared to an apparatus that returns to the normal mode from the sleep mode when the pyroelectric sensor 410 having a wide detection range detects a human. That is, the image forming apparatus 1 in the exemplary embodiments more accurately detects a human with an intention to use the image forming apparatus 1, and then returns to the normal mode from the sleep mode.

The camera 500 is an example of an image capturing unit that captures images, and captures an image of the vicinity of the image forming apparatus 1. In particular, the camera 500 is provided to capture an image of a human in the vicinity of the image forming apparatus 1. For example, the camera 500 includes an optical system that converges an image of the vicinity of the image forming apparatus 1, and an image sensor that detects the image converged by the optical system. The optical system is formed of a single lens or a combination of plural lenses. The image sensor has a configuration in which imaging elements such as charge coupled devices (CCDs) or complementary metal oxide semiconductors (CMOS) are arrayed. The camera 500 captures at least one of a still image and a moving image.

The microphone 600 acquires sounds from the vicinity of the image forming apparatus 1. In particular, the microphone 600 acquires a voice of a user of the image forming apparatus 1. The type of the microphone 600 is not limited to a specific type, and various types of production microphones such as a dynamic microphone and a condenser microphone may be used. A non-directional micro-electromechanical system (MEMS) microphone is preferably used as the microphone 600.

The speaker 700 outputs a sound to the vicinity of the image forming apparatus 1. For example, the speaker 700 guides a user of the image forming apparatus 1 via a voice. The speaker 700 outputs an alarm sound to a user of the image forming apparatus 1. A sound output from the speaker 700 is prepared as sound data in advance. For example, a sound is played back via the speaker 700 based on sound data corresponding to a state of the image forming apparatus 1 and a user's operation.

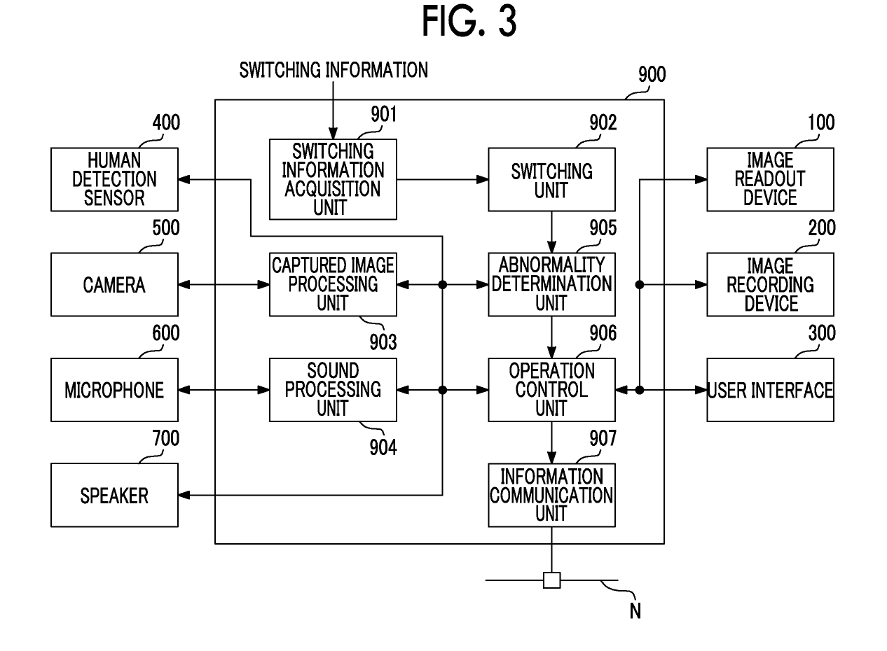

Hereinafter, the control device 900 will be described. FIG. 3 is a block diagram illustrating an example of a functional configuration of the control device 900. FIG. 3 selectively illustrates functions related to the exemplary embodiments among various functions of the control device 900.

As illustrated, the control device 900 in the exemplary embodiments includes a switching information acquisition unit 901; a switching unit 902; a captured image processing unit 903; a sound processing unit 904; and an abnormality determination unit 905; an operation control unit 906, and an information communication unit 907.

In the exemplary embodiments, operation states of the image forming apparatus 1 include a normal mode in which mechanism units, for example, the image recording device 200 of the image forming apparatus 1 are in normal operation, and a surveillance mode for detecting abnormality in a predetermined surveillance region. That is, in the exemplary embodiments, in the surveillance mode, the image forming apparatus 1 is used as a surveillance apparatus.

The switching information acquisition unit 901 acquires switching information used to switch the operation state of the image forming apparatus 1 between the normal mode and the surveillance mode.

For example, the switching information is information regarding the illuminance of the vicinity of the image forming apparatus 1. That is, when the vicinity of the image forming apparatus 1 is bright, and has high illuminance, it is considered that a light or the like is turned on. In this case, the image forming apparatus 1 is desirably in the normal mode in which image formation or the like is performed. In contrast, when the vicinity of the image forming apparatus 1 is dark, and has low illuminance, it is considered that a light or the like is turned off. In this case, the image forming apparatus 1 is rarely in the normal mode in which image formation or the like is performed, and is desirably in the surveillance mode for detecting abnormality in the predetermined surveillance region. For example, the switching information acquisition unit 901 acquires information regarding illuminance from an illuminometer (not illustrated). In this case, the illuminometer serves as an illuminance detection unit that detects illuminance in the surveillance region.

The switching information is not limited to information regarding illuminance. For example, the operation state may be switched between the normal mode and the surveillance mode by a user's operating the user interface 300. When a user pushes a switching start button for switching to the surveillance mode from the normal mode, the operation state transitions to the surveillance from the normal mode. When a user inputs a security code, the operation state transitions to the surveillance mode from the normal mode. In this case, the switching information is set information which is input via the user interface 300. The face of a user may be authenticated using the camera 500 such that the operation state transitions to the surveillance mode from the normal mode.

The operation state may be switched between the normal mode and the surveillance mode by day and time. For example, it is considered that the image forming apparatus 1 is in the normal mode for weekday daytime, and the image forming apparatus 1 is in the surveillance mode for weekday nighttime and weekends. In this case, the switching information is information regarding day and time.

Information as to whether a light switch for the surveillance region is turned on or off, and a door to the surveillance region is locked or unlocked may be acquired as the switching information. In this case, when the light switch is turned on, it is considered that the image forming apparatus 1 is in the normal mode, and when the light switch is turned off, it is considered that the image forming apparatus 1 is in the surveillance mode. In addition, when the door is unlocked, it is considered that the image forming apparatus 1 is in the normal mode, and when the door is locked, it is considered that the image forming apparatus 1 is in the surveillance mode.

The surveillance region represents a range for surveillance when the image forming apparatus 1 serves as a surveillance apparatus. For example, the surveillance region is a detection region of the human detection sensor 400 or an imaging range of the camera 500. Alternatively, the surveillance region is an inner space of a room in which the image forming apparatus 1 is installed.

The switching unit 902 is an example of a switching unit that switches the operation state of the image forming apparatus 1 between the normal mode and the surveillance mode. The switching unit 902 switches the operation state of the image forming apparatus 1 based on the switching information regarding illuminance or the like acquired by the switching information acquisition unit 901.

The captured image processing unit 903 processes an image captured by the camera 500. In the normal mode, the camera 500 captures an image of the face of a user of the image forming apparatus 1. The captured image processing unit 903 recognizes the user based on the image captured by the camera 500. The recognition of a user implies the authentication of the user, for example. The authentication of a user is performed in such a way that an image of the face of the user is recorded as image data in advance, and the captured image processing unit 903 compares the recorded image of the face with the image captured by the camera 500. The authentication of a user is the detection of the user, for example. When an image captured by the camera 500 includes an image of a human's face, it is detected that a user of the image forming apparatus 1 is present in front of the image forming apparatus 1.

In contrast, in the surveillance mode, the camera 500 captures an image of an intruder who intrudes in the surveillance region. In this case, the captured image processing unit 903 stores data of the captured image. Since an intruder may break the image forming apparatus 1, the captured image processing unit 903 may transmit the data of the captured image to external equipment via the information communication unit 907 or a communication line N. Incidentally, the camera 500 maybe used to detect abnormality in the surveillance region based on the captured image.

The sound processing unit 904 processes the sound acquired by the microphone 600. In the normal mode, when a user inputs a voice via the microphone 600, the sound processing unit 904 authenticates the user based on the voice acquired by the microphone 600. This authentication is performed in such a way that a power spectrum indicative of a relationship between the frequency and the intensity of a user's voice is recorded in advance, and the sound processing unit 904 compares the recorded power spectrum with the power spectrum of the voice acquired by the microphone 600.

A user sets image forming conditions of the image recording device 200 or starts the operation of the image recording device 200 by issuing a voice instruction (voice operation command) via the microphone 600. The voice operation commands are registered in a dictionary for registration in advance, and the sound processing unit 904 determines an intention of a user by comparing the voice of the user with the content of the dictionary for registration.

In contrast, in the surveillance mode, the microphone 600 acquires a sound in the surveillance region. The abnormality determination unit 905 (to be described hereinafter) uses the acquired sound so as to detect abnormality in the surveillance region. In the surveillance mode, the sound processing unit 904 processes the sound according to an abnormality determination process executed by the abnormality determination unit 905. For example, the sound processing unit 904 prepares the power spectrum of a sound, or amplifies a sound signal.

In the surveillance mode, the abnormality determination unit 905 determines whether abnormality occurs in the surveillance region. In the exemplary embodiments, the abnormality determination unit 905 determines whether abnormality occurs in the surveillance region based on mainly the sound acquired by the microphone 600.

Specifically, when the microphone 600 acquires a voice that is not registered in the dictionary for registration, the abnormality determination unit 905 determines the occurrence of abnormality. When the sound acquired by the microphone 600 exceeds a predetermined sound volume level, the abnormality determination unit 905 determines the occurrence of abnormality. When the microphone 600 acquires a sound exceeding a predetermined frequency of occurrence, the abnormality determination unit 905 determines the occurrence of abnormality. Alternatively, the occurrence of abnormality is determined by analyzing the frequency of the sound acquired by the microphone 600. For example, when a sound is a scream, the sound has distinctive characteristics in a frequency distribution, and thus the sound acquired by the microphone 600 is capable of being determined to be a scream by analyzing the frequency of the sound. A door opening sound, a glass window break sound, and the like are registered in the dictionary for registration as abnormal sounds caused by the occurrence of abnormality, and when an abnormal sound acquired by the microphone 600 coincides with any one of the registered sounds, the occurrence of abnormality may be determined. The distance to or the direction of a source of sound generation may be obtained by providing plural the microphones 600. The abnormality determination unit 905 may determine whether the source of sound generation is present in the surveillance region. When the source of sound generation is present in the surveillance region, the abnormality determination unit 905 may determine the occurrence of abnormality, and when the source of sound generation is out of the surveillance region, the abnormality determination unit 905 may determine that abnormality does not occur.

The operation control unit 906 controls operations of the image readout device 100, the image recording device 200, the user interface 300, the human detection sensor 400, the camera 500, the microphone 600, and the speaker 700. In both the normal mode and the surveillance mode, the operation control unit 906 determines and controls operations of the image readout device 100, the image recording device 200, the user interface 300, the human detection sensor 400, the camera 500, the microphone 600, and the speaker 700 based on pieces of information acquired from the user interface 300, the human detection sensor 400, the camera 500, the microphone 600, and the like.

The information communication unit 907 is connected to the communication line N, and transmits to and receives signals from the communication line N. The communication line N is a network such as a local area network (LAN), a wire area network (WAN), or Internet. The communication line N may be a public telephone line. The information communication unit 907 is used to receive a print job that is transmitted from a PC or the like connected to the communication line N, or to transmit image data of a document, which is read by the image readout device 100, to external equipment.

### Description of Operation of Image Forming Apparatus

The image forming apparatus 1 with the aforementioned configuration operates as described below.

First, an operation of the image forming apparatus 1 in the normal mode will be described.

In the normal mode, a user may make a copy of a document using the image forming apparatus 1. A user may print a document by transmitting a print job to the image forming apparatus 1 via a PC or the like connected to the communication line N. A user may transmit and receive a facsimile via the communication line N. Alternatively, a user may scan a document and store image data in the image forming apparatus 1 or a PC connected to the communication line N.

Hereinbelow, in a case where a user make a copy of a document, an operation of the image forming apparatus 1 in the normal mode will be described in detail.

When the image forming apparatus 1 is in the sleep mode, and the pyroelectric sensor 410 of the human detection sensor 400 detects a human approaching the image forming apparatus 1, as described above, power to the reflective sensor 420 is turned on. When the reflective sensor 420 detects the human within the predetermined time, the image forming apparatus 1 determines that the approaching human is a user to use the image forming apparatus 1, and the image forming apparatus 1 returns to the normal mode from the sleep mode. In order to determine that the approaching human is a user to use the image forming apparatus 1, the camera 500 may be used instead of the reflective sensor 420.

In the normal mode, when a user look at the camera 500, the camera 500 captures an image of the face of the user, and the control device 900 authenticates the user.

When a user inputs a voice via the microphone 600 in the normal mode, the control device 900 authenticates the user based on the voice acquired by the microphone 600.

A user sets image forming conditions or the like of the image recording device 200 by operating the user interface 300. When setting is performed over many steps or the like, a user may issue instructions by inputting voices via the microphone 600, which is assistance to the user. At this time, the image forming apparatus 1 may output voice guide regarding the setting via the speaker 700 such that the setting is performed in a conversation manner. When a user erroneously performs an operation, the speaker 700 may output voice guide or the like to prompt the user to correct the operation. At the occurrence of paper jam or the like, the speaker 700 may output voice guide or the like to prompt a user to remove jammed paper. In addition, for example, the speaker 700 is used to output an alarm sound to a user when a copy job or a print job is completed, or when a facsimile is received. The alarm sound may be not only a beep sound but also a melody or a voice.

When a user places a document on the platen glass 111 or the document accommodation unit 121 of the image readout device 100, and pushes a start key or the like on the user interface 300, the image readout device 100 reads an image of the document. The read image of the document undergoes a predetermined image processing, image-processed image data is converted to color tone data for four colors such as yellow (Y), magenta (M), cyan (C), and black (K), and the tone data is output to the optical unit 50.

According to the input color tone data, the optical unit 50 emits a laser beam, which is emitted from the semiconductor laser (not illustrated), to the polygon mirror via an f-θ lens (not illustrated). According to the tone data for each color, the polygon mirror modulates and scans the incident laser beam in a deflective manner, and irradiates the photoconductor drums 22 of the image forming units 21Y, 21M, 21C, and 21K with the laser beam via the image forming lens and plural mirrors (not illustrated).

The surfaces of the photoconductor drums 22 of the image forming units 21Y, 21M, 21C, and 21K are scanned and exposed to light, with the surface charged by the chargers 23, and electrostatic latent images are formed on the surfaces. The formed electrostatic latent images are developed as toner images for yellow (Y), magenta (M), cyan (C), and black (K) in the image forming units 21Y, 21M, 21C, and 21K. The toner images formed on the photoconductor drums 22 of the image forming units 21Y, 21M, 21C, and 21K are multi-transferred on the intermediate transfer belt 31 that is an intermediate transfer medium.

In contrast, in the paper supply unit 60, the feeding roller 62 rotates at a time the images are formed, the paper P accommodated in the paper accommodation unit 61 is picked up, and the paper P is transported to the transport rollers 64 and 65 via the transporting path 63. Subsequently, the transport roller 66 rotates at a time the intermediate transfer belt 31 having the toner images thereon moves, and the paper P is transported to the secondary transfer position by the backup roller 35 and the secondary transfer roller 41. At the secondary transfer position, the four-color toner images superimposed on each other are sequentially transferred on the paper P (which is being transported from a bottom side to an upper side) in a secondary scanning direction using press-contact force and a predetermined electric field. After the paper P having the transferred four-color toner images thereon is fixed by the fixing device 45 using heat and pressure, the paper P is output and carried on the first carrying tray 71 or the second carrying tray 72.

When the image forming apparatus 1 receives a request for double-sided printing, an image is formed on one surface of the paper P, the paper P is transported such that the back surface of the paper P is reversed by the reverse transporting unit 80, and then the paper P is transported toward the secondary transfer position again. At the secondary transfer position, a toner image is transferred on the other surface of the paper P, and the transferred image is fixed by the fixing device 45. Subsequently, the paper P having the images on both surfaces is output and carried in the first carrying tray 71 or the second carrying tray 72.

Hereinafter, an operation of the image forming apparatus 1 in the surveillance region will be described.

In the exemplary embodiments, the image forming apparatus 1 make use of the function of each of the image readout device 100, the image recording device 200, the user interface 300, the human detection sensor 400, the camera 500, the microphone 600, and the speaker 700.

### First Exemplary Embodiment

First, a first exemplary embodiment will be described.

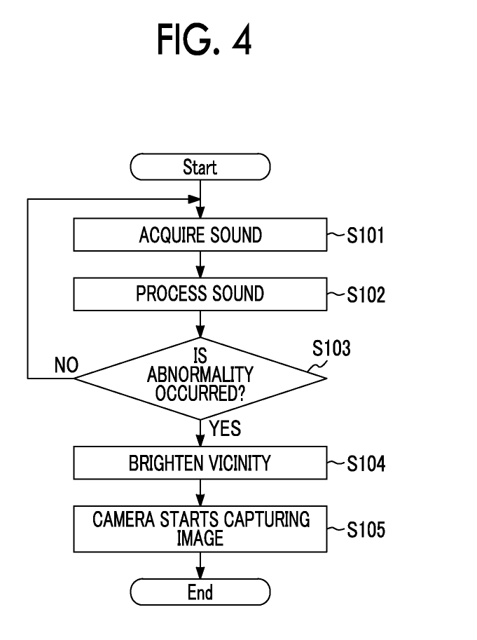

FIG. 4 is a flowchart illustrating an operation of the image forming apparatus 1 according to the first exemplary embodiment.

In the surveillance region, the image forming apparatus 1 acquires a sound via the microphone 600 (step S101). The sound processing unit 904 process the sound acquired by the microphone 600 (step S102), and the abnormality determination unit 905 determines the occurrence of abnormality based on the sound acquired by the microphone 600 (step S103).

When the abnormality determination unit 905 determines that abnormality does not occur (No in step S103), the process returns to step S101.

In contrast, when the abnormality determination unit 905 determines the occurrence of abnormality (Yes in step S103), the operation control unit 906 causes each of the image readout device 100, the image recording device 200, the user interface 300, the human detection sensor 400, the camera 500, the microphone 600, and the speaker 700 to perform a predetermined operation. An operation is performed to brighten the vicinity of the image forming apparatus 1 (step S104). Specifically, the light irradiating unit 112 of the image readout device 100 is turned on, or the backlight of the touch panel of the user interface 300 is turned on. A light in the surveillance region may be turned on.

The camera 500 starts to capture an image (step S105). Accordingly, when an intruder is present in the vicinity of the image forming apparatus 1, an image of the intruder is captured. The captured image is stored as described above. At this time, the microphone 600 may also continue to acquire sounds, and the acquired sound may be stored.

In the first exemplary embodiment, when abnormality does not occur in the surveillance mode, the camera 500 stops capturing an image. Instead, the microphone 600 operates as a detection unit that detects abnormality. At the occurrence of abnormality, the acquisition of an image is started. That is, in the surveillance mode, typically, a light or the like is turned off, and the vicinity of the image forming apparatus 1 is dark. The camera 500 is provided to recognize a user in the normal mode, for example, and in many cases, the camera 500 is used when the vicinity of the image forming apparatus 1 is bright. When the vicinity of the image forming apparatus 1 is dark, even if the camera 500 operates, it may become difficult for the camera 500 to capture a clear image. Accordingly, in the exemplary embodiments, when abnormality does not occur, the operation of the camera 500 is stopped, and at the occurrence of abnormality, the vicinity of the image forming apparatus 1 is brightened. The camera 500 is capable of capturing a more clear image by capturing an image in this state. In the first exemplary embodiment, when abnormality does not occur in the surveillance mode, the operation of the camera 500 is stopped, and the microphone 600 operates. The microphone 600 has power consumption that is lower than that of the camera 500. Accordingly, power consumption when the detection of abnormality by the microphone 600 is performed is reduced compared to when the detection of abnormality by the camera 500 is performed.

### Second Exemplary Embodiment

Hereinafter, a second exemplary embodiment will be described.

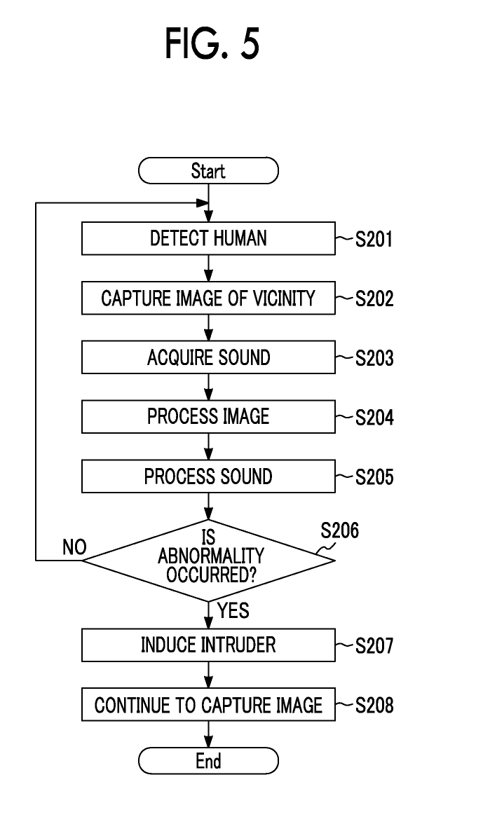

FIG. 5 is a flowchart illustrating an operation of the image forming apparatus 1 according to the second exemplary embodiment.

In the surveillance mode, the image forming apparatus 1 detects a human entering the surveillance region using the pyroelectric sensor 410 of the human detection sensor 400 (step S201). The camera 500 captures an image of the vicinity of the image forming apparatus 1 (step S202). In this case, the camera 500 is capable of capturing an image also in the surveillance mode. The microphone 600 acquires a sound (step S203).

Subsequently, the captured image processing unit 903 processes the image captured by the camera 500 (step S204). The sound processing unit 904 processes the sound acquired by the microphone 600 (step S205).

The abnormality determination unit 905 determines whether abnormality occurs, based on a detection signal from the pyroelectric sensor 410, the sound acquired by the microphone 600, and the image captured by the camera 500 (step S206). When the pyroelectric sensor 410 detects a human, the abnormality determination unit 905 determines the occurrence of abnormality. When the image captured by the camera 500 includes an image of a human, the occurrence of abnormality is determined. That is, an intruder intruding in the surveillance region is detected.

When the abnormality determination unit 905 determines that abnormality does not occur (No in step S206), the process returns to step S201.

In contrast, when the abnormality determination unit 905 determines the occurrence of abnormality (Yes in step S206), the operation control unit 906 causes each of the image readout device 100, the image recording device 200, the user interface 300, the human detection sensor 400, the camera 500, the microphone 600, and the speaker 700 to perform a predetermined operation. An operation is performed to induce the intruder (step S207). Specifically, the abnormality determination unit 905 performs an operation to prompt the intruder to operate the image forming apparatus 1. As an example of the operation to prompt the intruder to operate the image forming apparatus 1, the abnormality determination unit 905 performs an operation to prompt the intruder to stop at least one of a sound and image display. For example, the speaker 700 outputs an alarm sound, and outputs a voice message that “an intruder is detected, and if you are not an intruder, please push a stop button”. A message with the same content may be displayed on the touch panel of the user interface 300. Similarly, the abnormality determination unit 905 may prompt the intruder to stop a notification indicative of intrusion of an intruder by transmission using a telephone, an e-mail, a facsimile, or the like. The intruder may be prompted to stop the storing (to be performed in the next step S208) or the transmission of the captured image or the sound acquired by the microphone 600.

The camera 500 continuously captures images (step S208). Accordingly, an image of the induced intruder is captured (step S208). In this case, the captured image is stored. A sound acquired by the microphone 600 may also be stored.

In the second exemplary embodiment, the human detection sensor 400, the camera 500, and the microphone 600 operate as a detection unit that detects abnormality. At least one of the human detection sensor 400, the camera 500, and the microphone 600 may operate, and serve as a detection unit, and all of the human detection sensor 400, the camera 500, and the microphone 600 are not necessarily required to operate. When an intruder is detected, an operation is performed to cause the intruder to come to and operate the image forming apparatus 1. In this case, the speaker 700 or the user interface 300 serves as an induction unit that induces the intruder. An image of the induced intruder is captured by the camera 500. Accordingly, pieces of information regarding the intruder are more acquired.

### Third Exemplary Embodiment

Hereinafter, a third exemplary embodiment will be described.

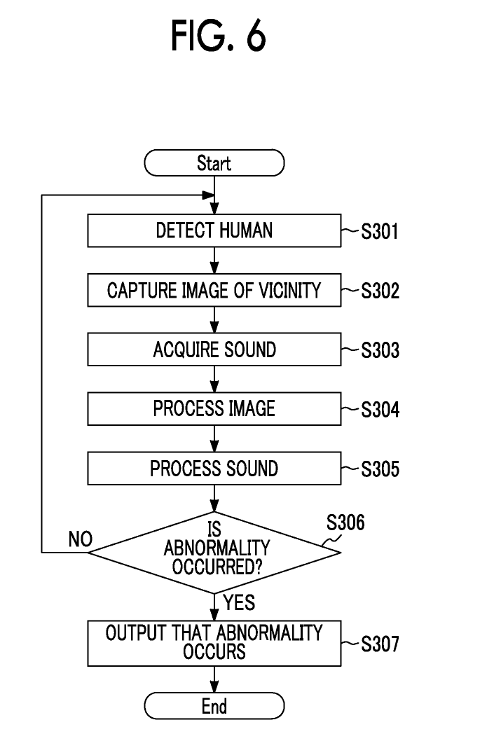

FIG. 6 is a flowchart illustrating an operation of the image forming apparatus 1 according to the third exemplary embodiment.

Steps S301 to S306 in FIG. 6 are equivalent to steps S201 to S206 in FIG. 5, and thus descriptions thereof will be omitted.

In the exemplary embodiment, when the abnormality determination unit 905 determines the occurrence of abnormality (Yes in step S306), the abnormality determination unit 905 outputs a message indicative of the occurrence of abnormality (step S307). Specifically, the outside of the image forming apparatus 1 is notified with the occurrence of abnormality. Other equipment is notified with a message indicative of the occurrence of abnormality, and a coordinated operation is performed. The notification is performed via the information communication unit 907 or the communication line N. That is, when abnormality is detected, the information communication unit 907 serves an output unit that outputs a message indicative of the occurrence of abnormality.

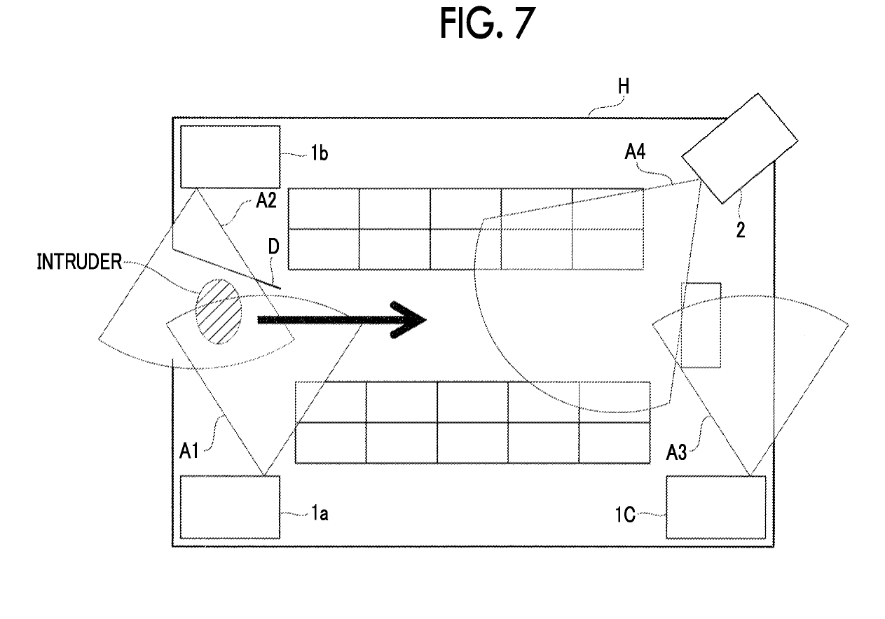

FIG. 7 is a diagram exemplifying a case in which a coordinated operation between the image forming apparatus 1 and other equipment is performed.

In FIG. 7, three image forming apparatuses 1a, 1b, and 1c are installed as the image forming apparatuses 1 at three corners of four corners of a room H. A surveillance camera 2 is installed at one remaining corner of the four corners of the room H. Surveillance regions of the image forming apparatuses 1a, 1b, and 1c are illustrated by surveillance regions A1, A2, and A3, respectively. A surveillance region of the surveillance camera 2 is illustrated by a surveillance region A4. The surveillance regions A1, A2, and A3 are, for example, detection regions of the human detection sensors 400, imaging ranges of the cameras 500, and sound acquisition ranges of the microphones 600 of the image forming apparatuses 1a, 1b, and 1c. The surveillance region A4 is, for example, an imaging range of the surveillance camera 2.

For example, it is assumed that an intruder opens the door D and intrudes in the room H. At this time, when the intruder intrudes in the surveillance region A1, the image forming apparatus 1a detects the intruder. The image forming apparatus 1b is blocked by the door D, and thus the image forming apparatus 1b is not capable of detecting the intruder. Since the intruder is present outside the surveillance regions A3 and A4, similarly, the image forming apparatus 1c and the surveillance camera 2 also are not capable of detecting the intruder.

The image forming apparatus 1a notifies other equipment such as the image forming apparatuses 1b and 1c and the surveillance camera 2 with a message indicative of the occurrence of abnormality, and performs a coordinated operation therewith.

For example, the image forming apparatuses 1a, 1b, and 1c perform the operations described in the first and second exemplary embodiments. The surveillance camera 2 changes a surveillance direction such that the surveillance camera 2 faces the image forming apparatus 1a, and the surveillance camera 2 captures an image of the intruder. That is, the surveillance camera 2 operates as coordination equipment that operates in coordination with the image forming apparatuses 1a, 1b, and 1c. In this case, as a coordinated operation, the surveillance camera 2 performs an operation of capturing an image in a direction in which the image forming apparatus 1a having detected abnormality is disposed.

In the third exemplary embodiment, the human detection sensor 400, the camera 500, and the microphone 600 operate as a detection unit that detects abnormality. The image forming apparatuses 1a, 1b, and 1c and the surveillance camera 2 may be treated as a surveillance system.

In the surveillance system, the respective surveillance regions A1, A2, and A3 of the image forming apparatuses 1a, 1b, and 1c and the surveillance region A4 of the surveillance camera 2 is wide. In the third exemplary embodiment, under the coexistence of the image forming apparatuses 1a, 1b, and 1c with narrow surveillance regions, and the surveillance camera 2 with a wide surveillance region, when any one of the image forming apparatuses 1a, 1b, and 1c detects abnormality, the image forming apparatus is capable of widening the surveillance region in coordination with the surveillance camera 2. In the third exemplary embodiment, when an intruder is detected, the image forming apparatus 1 performs a coordinated operation with other equipment, and thus the image forming apparatus 1 acquires much more information regarding the intruder. In this case, the image forming apparatus 1 may be connected to an already-installed security system, and the already-installed security system is further reinforced.

In the first to third exemplary embodiments, the image forming apparatus 1 makes use of the equipment that is already built therein, and effectively utilizes the equipment, and thus the image forming apparatus 1 serves as a surveillance apparatus. That is, in the normal mode in which the image recording device 200 forms an image, the detection unit and the induction unit described above are used as they are. In this case, it is less required to purchase new equipment, and the provision of high-level security is realized at low costs.

In the aforementioned examples, a sound is acquired by the microphone 600; however, the present invention is not limited to that configuration. For example, a unit may be disposed inside the image forming apparatus 1, and acquire an operation sound of the image recording device 200. In the normal mode, the unit monitors an operation sound of the image recording device 200, and operates as equipment that determines a malfunction of the image recording device 200 when a sound with a predetermined magnitude is detected. In the surveillance mode, similar to the microphone 600, the unit is used as the detection unit that acquires a sound in the vicinity of the image forming apparatus 1.

A unit may be disposed inside the image forming apparatus 1, and acquire the vibrations of the image recording device 200. In the normal mode, the unit monitors the vibrations of the image recording device 200, and operates as equipment that determines a malfunction of the image recording device 200 when vibrations with a predetermined magnitude is detected. In the surveillance mode, the unit is used as the detection unit that acquires the vibrations in the vicinity of the image forming apparatus 1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A surveillance apparatus comprising:
a detection unit that detects an intruder who intrudes in a predetermined surveillance region; and
an induction unit that induces the intruder when the intruder is detected.

2. The surveillance apparatus according to claim 1,
wherein the induction unit induces the intruder by prompting the intruder to operate the surveillance apparatus.

3. The surveillance apparatus according to claim 1, further comprising:
an image forming unit that forms an image on a recording medium,
wherein the detection unit and the induction unit are used in a normal mode in which an image is formed by the image forming unit.

4. The surveillance apparatus according to claim 2, further comprising:
an image forming unit that forms an image on a recording medium,
wherein the detection unit and the induction unit are used in a normal mode in which an image is formed by the image forming unit.

5. The surveillance apparatus according to claim 3, further comprising:
a switching unit that switches an operation state between a normal mode in which the image forming unit operates normally and a surveillance mode for detecting the intruder.

6. The surveillance apparatus according to claim 4, further comprising:
a switching unit that switches an operation state between a normal mode in which the image forming unit operates normally and a surveillance mode for detecting the intruder.

7. The surveillance apparatus according to claim 3,
wherein, in the normal mode, the detection unit is at least one of a unit that acquires a voice of a user of the surveillance apparatus, a unit that acquires an operation sound of the image forming unit, a unit that acquires vibrations of the image forming unit, and an image capturing unit that captures an image.

8. The surveillance apparatus according to claim 4,
wherein, in the normal mode, the detection unit is at least one of a unit that acquires a voice of a user of the surveillance apparatus, a unit that acquires an operation sound of the image forming unit, a unit that acquires vibrations of the image forming unit, and an image capturing unit that captures an image.

9. The surveillance apparatus according to claim 5,
wherein, in the normal mode, the detection unit is at least one of a unit that acquires a voice of a user of the surveillance apparatus, a unit that acquires an operation sound of the image forming unit, a unit that acquires vibrations of the image forming unit, and an image capturing unit that captures an image.

10. The surveillance apparatus according to claim 6,
wherein, in the normal mode, the detection unit is at least one of a unit that acquires a voice of a user of the surveillance apparatus, a unit that acquires an operation sound of the image forming unit, a unit that acquires vibrations of the image forming unit, and an image capturing unit that captures an image.

11. The surveillance apparatus according to claim 1, further comprising:
an image capturing unit that captures an image of the intruder when the intruder is induced by the induction unit, and is used in the normal mode in which the image forming unit forms an image.

12. The surveillance apparatus according to claim 2, further comprising:
an image capturing unit that captures an image of the intruder when the intruder is induced by the induction unit, and is used in the normal mode in which the image forming unit forms an image.

13. The surveillance apparatus according to claim 3, further comprising:
an image capturing unit that captures an image of the intruder when the intruder is induced by the induction unit, and is used in the normal mode in which the image forming unit forms an image.

14. The surveillance apparatus according to claim 4, further comprising:
an image capturing unit that captures an image of the intruder when the intruder is induced by the induction unit, and is used in the normal mode in which the image forming unit forms an image.

15. The surveillance apparatus according to claim 5, further comprising:
an image capturing unit that captures an image of the intruder when the intruder is induced by the induction unit, and is used in the normal mode in which the image forming unit forms an image.

16. The surveillance apparatus according to claim 6, further comprising:
an image capturing unit that captures an image of the intruder when the intruder is induced by the induction unit, and is used in the normal mode in which the image forming unit forms an image.
